(19) United States
(12) Patent Application Publication
(10) Pub. No.: US 2026/0180058 A1
(43) Pub. Date: Jun. 25, 2026

(54) SYSTEM AND METHOD FOR TRANSFERRING TEMPERATURE

(71) Applicant: Fluence Energy, LLC, Arlington, VA (US)

(72) Inventors: Kathryn Corine Streng Callahan, Superior, CO (US); Herman Karl Phlegm, West Bloomfield, MI (US); Omar Dauleh, Cambridge, MA (US)

(73) Assignee: Fluence Energy, LLC, Arlington, VA (US)

(21) Appl. No.: 18/840,099

(22) PCT Filed: Aug. 7, 2024
(86) PCT No.: PCT/US2024/041181

§ 371 Date: Aug. 21, 2024

Related U.S. Application Data
(60) Provisional application No. 63/531,430, filed on Aug. 8, 2023.

(51) Int. Cl. H01M 10/613; H01M 10/6556

(52) U.S. Cl. CPC H01M 10/613; H01M 10/6556

(57) ABSTRACT

An energy storage system includes a plurality of energy storage nodes, each of which includes an energy storage element, at least one cold plate, and a coolant manifold coupled to the at least one cold plate. The coolant manifold splits coolant flow in a bi-directional type configuration at a front and in an interior of the cold plate. A method for assembling an energy storage cooling system is also provided.

### CROSS-REFERENCE TO RELATED APPLICATIONS

This application claims priority under 35 U.S.C. § 120 to U.S. Patent Application No. 63/531,430 filed on Aug. 8, 2023, titled “System and Method For Transferring Temperature,” the entire disclosure of which is hereby incorporated by reference herein.

### TECHNICAL FIELD

The present subject matter relates to exemplary systems and methods for cooling an array of battery cells within a battery module of a battery energy storage system.

### BACKGROUND

Battery energy storage systems, compound energy storage systems, as well as some energy provisioning systems, have a pervasive issue with heat generation. Dispersal or removal of this generated heat is paramount to the success of the battery energy storage system. Improved heat transfer capability consequently improves the lifespan and safety of heat-generating, as well as heat-experiencing, components of the battery energy storage system.

Further, the size of modern battery modules in battery energy storage systems present a unique problem for cooling their battery cells. Even thermal regulation of temperature within a battery module across the battery cells is critical to the life of the overall battery module and the constituent battery cells. The life of a battery cell is dependent upon on keeping the battery cell within a certain temperature range. Additionally, for the battery cell to experience even wear, the cell to cell temperature range must also be within reasonable parameters. The larger the area of battery cells within the battery module, the more difficult it is to keep the temperature range of the individual cells under a certain limit, and the cell to cell temperature range within a certain variance, using only a single cold plate.

Hence, there in a need for systems and methods directed to even thermal regulation of battery cells within a battery module of a battery energy storage system.

### SUMMARY

In a first example, an energy storage system 101 includes a plurality of energy storage nodes 105A-N, each of which includes a battery storage element 106A-N, at least one cold plate 500, and a coolant manifold 600 coupled to the at least one cold plate 500. The coolant manifold 600 is configured to split coolant flow in a bi-directional type configuration at a front and in an interior of the cold plate 500.

In a second example, a method for assembling an energy storage system 101 includes providing a plurality of energy storage nodes 105A-N, each of which includes a battery storage element 106A-N, coupling at least one cold plate 500 to each of the plurality of energy storage nodes 105A-N, and coupling a coolant manifold 600 to the at least one cold plate 500. The coolant manifold 600 is configured to split coolant flow in a bi-directional type configuration at a front and in an interior of the cold plate 500.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 depicts a system that includes an energy storage system, an energy system, and an electrical application.

FIG. 2 illustrates a first energy storage node of a plurality of energy storage nodes of the energy storage system of FIG. 1 coupled to the electrical application.

FIG. 3 is a cutaway view of the first energy storage node of the plurality of energy storage nodes and shows details of a plurality of battery storage elements.

FIG. 4 is a heat gradient diagram of a conventional cold plate installed in a battery module.

FIG. 5 is a diagram of a preferred coolant flow across a cold plate in order to reduce temperature variance among battery cells in a battery module.

FIG. 6 is an isometric view of a cold plate manifold configured to improve temperature variance among battery cells in a battery module.

FIG. 7 is an isometric view of the cold plate manifold of FIG. 6 brazed to a cold plate, with arrows indicating the flow of coolant across the cold plate.

FIG. 8 a top-down view of the cold plate of FIG. 7, depicting the flow path of coolant at the junction between the cold plate and the cold plate manifold.

FIG. 9 is a longitudinal view of the cold plate of FIG. 7, depicting the inflow and outflow channels for the coolant.

FIG. 10 is a flowchart depicting a method for assembling an energy storage system, according to an embodiment.

Parts Listing

| | |
|---|---|
| 100 | System |
| 101 | Energy Storage System |
| 102 | Energy System |
| 103 | Electrical Application |
| 104 | Power Conversion System |
| 105A-N | Energy Storage Nodes |
| 106, 106A-N | Battery Storage Elements |
| 107 | Power Conversion Subsystem |
| 108 | Transformer |
| 109 | Energy Source |
| 110 | Control Subsystem |
| 115 | Control System |
| 120 | Physical Space |
| 125 | Power Bus |
| 205 | Power Inverter |
| 210 | Rectifier |
| 215 | DC-DC Converter |
| 300 | Enclosure |
| 400, 500, 700 | Cold Plate |
| 402, 602 | Coolant Inflow |
| 404, 604 | Coolant Outflow |
| 405A-Z, 505A-Z | Battery cells |
| 600 | Coolant Manifold |
| 612 | Inflow Trough |
| 614 | Outflow Trough |
| 702 | Cold Plate End |
| 704 | Cold Plate Beginning |
| 712A-D | Inlet Channels |
| 714A-D | Outlet Channels |
| 800 | Method |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, transfer functions, and/or circuitry have been described at a relatively high-level, without detail, in order to avoid unnecessarily obscuring aspects of the present teachings.

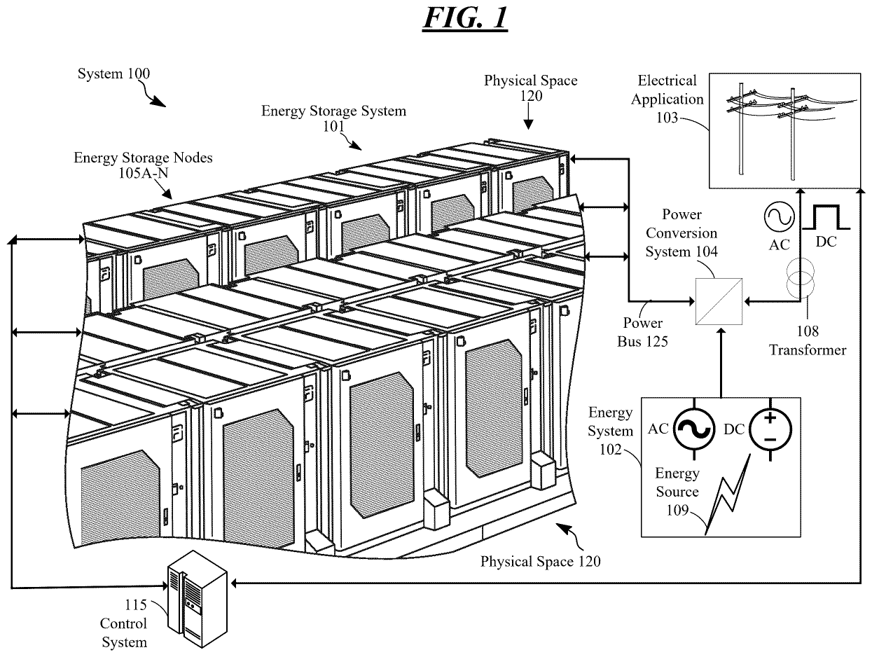

Unless otherwise indicated, any embodiment can be combined with any other embodiment. In particular, FIGS. 1-10 and the associated text are all combinable with each other.

The term “coupled” as used herein refers to any logical, physical, electrical, or optical connection, link or the like by which signals or light produced or supplied by one system element are imparted to another coupled element. Unless described otherwise, coupled elements or devices are not necessarily directly connected to one another and may be separated by intermediate components, elements, or communication media that may modify, manipulate, or carry the light or signals.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N; or component of an energy storage system 101 or energy storage nodes 105A-N constructed as otherwise described herein.

Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

Reference now is made in detail to the examples illustrated in the accompanying drawings and discussed below.

FIG. 1 depicts a system 100 that includes an energy storage system 101, energy system 102, and an electrical application 103. For example, the energy storage system 101 can be a battery energy storage system (BESS). The energy storage system 101 is coupled to the energy system 102 and the electrical application 103. Energy storage system 101 can include a power conversion system 104, a plurality of energy storage nodes 105A-N, an optional transformer 108, and a control system 115. Components of the energy storage system 101 can be located at a physical space 120 that is outdoors or indoors, for example, inside of a building, a container, or other structure.

Power conversion system 104 is coupled to the plurality of energy storage nodes 105A-N. The power conversion system 104 is coupled to the energy system 102 and the electrical application 103 to provide a required power flow to the electrical application 103 by discharging the plurality of energy storage nodes 105A-N or the required power flow from the energy system 102 for charging the plurality of energy storage nodes 105A-N. The power conversion system 104 can be coupled to an optional transformer 108. The optional transformer 108 can step up or step down the required power flow to and from the electrical application 103, such as an AC voltage.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow of the electrical application 103.

Energy storage nodes 105A-N include battery storage elements 106A-N. The battery storage elements 106A-N can be: (1) a single battery cell; (2) a cell grouping, including several battery cells in parallel configuration; (3) a battery submodule or module, including several battery cells in parallel and serial configuration; (4) a battery string, including several battery modules in series; (5) a battery bank, including several battery strings in parallel; (6) other known energy storage elements; and/or (7) a combination thereof. For example, the battery storage elements 106A-N can include a plurality of batteries of any existing or future reusable battery technology that can be used in a battery energy storage system (BESS), including, but not limited to, lithium ion or flow batteries, or mechanical storage, such as flywheel energy storage, compressed air energy storage, pumped-storage hydroelectricity, gravitational potential energy, or a hydraulic accumulator, for example.

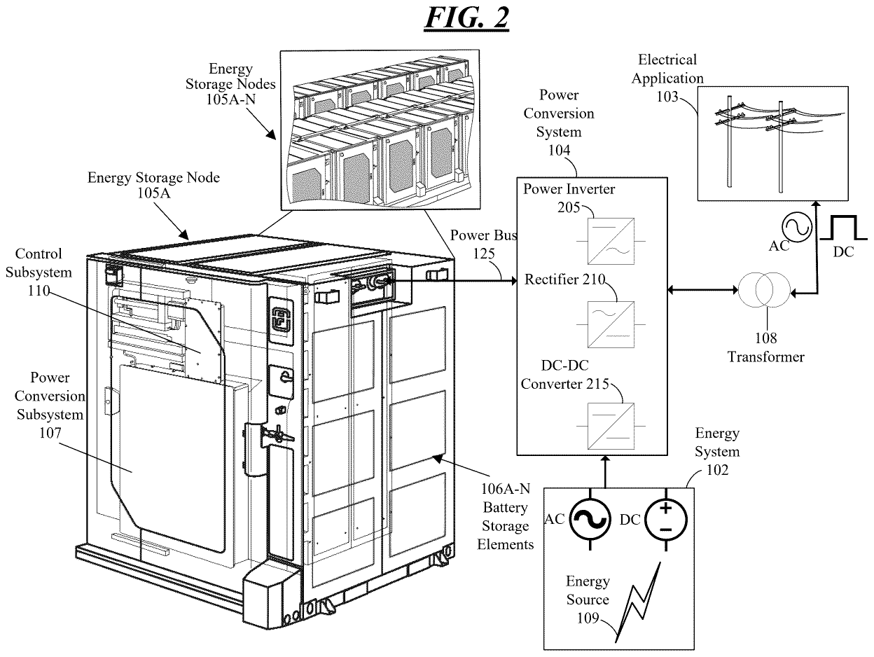

FIG. 2 illustrates a first energy storage node 105A of the plurality of energy storage nodes 105A-N of FIG. 1 coupled to the electrical application 103. Energy storage nodes 105A-N can include a battery storage element 106, a power conversion subsystem 107, and a control subsystem 110, or a combination thereof. Energy storage system 101 can be controlled such that the electrical application 103 is fulfilled while distributing the dispatch of required power flow across the plurality of battery storage elements 106A-N according to awareness of the control system 115 relating to certain battery conditions, including a state of charge, a temperature, and other physical phenomena occurring within the battery storage elements 106A-N.

Power conversion system 104 can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow from the energy storage system 101 from DC power into AC power during dispatch to the electrical application 103. For example, the power inverter 205 can be configured to convert power on a power bus 125 for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 is distributed more locally to each of energy storage nodes 105A-N. The control subsystem 110 can be configured for local computation, processing, and control of the battery storage elements 106A-N and the power conversion subsystem 107. The control system 115 can be configured for more centralized computation, processing, and controls of the overall energy storage system 101, energy system 102, electrical application 103, and power conversion system 104. Both the control subsystem 110 and control system 115 can include a single board computer, an application-specific integrated circuit (ASIC), microcontroller, digital signal processor (DSP), field-programmable gate array (FPGA), or a combination thereof.

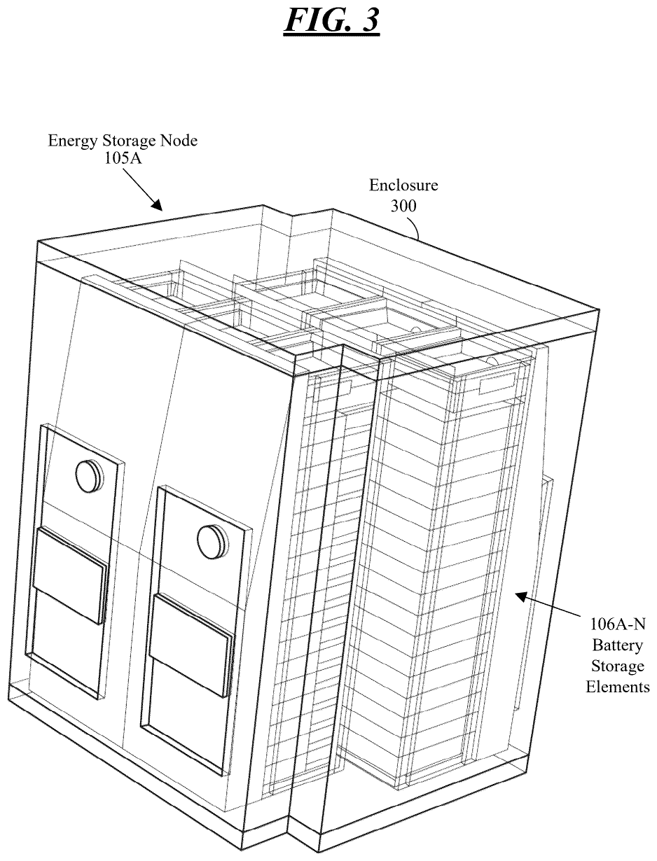

FIG. 3 is a cutaway view of the first energy storage node 105A of the plurality of energy storage nodes 105A-N and shows details of a plurality of battery storage elements 106A-N. As shown, the energy storage node 105A includes an enclosure 300, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 3, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

The energy storage nodes 105A-N may resemble the features presented in the energy storage system described in International Application No. PCT/US2021/30551, filed on May 4, 2021, titled “Energy Storage System with Removable, Adjustable, and Lightweight Plenums,” the entirety of which is incorporated by reference herein.

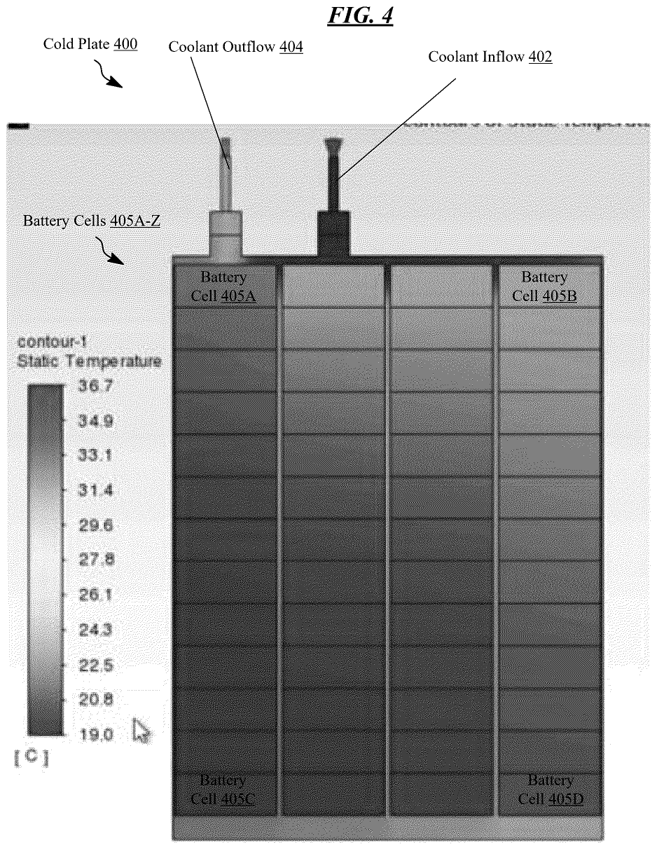

FIG. 4 is a top-down heat gradient diagram of a cold plate 400 installed in a battery storage element 106A. The cold plate 400 is generally installed across the bottom of the battery storage element 106A—as the battery cells 405A-Z are generally unstacked, and the battery cells 405A-Z are all in contact with the bottom of the battery storage element 106A, installing the cold plate 400 along the bottom of the battery storage element 106A ensures that each battery cell 405A-Z is in contact with the cold plate 400.

The cold inflow coolant is shown flowing in from the coolant inflow 402, dispersing across the cold plate 400 and the battery cells 405A-Z, and ultimately outflowing out the coolant outflow 404. The flow of coolant is undirected, resulting in the coolant forming a temperature gradient: the gradient generally describable as warmest on the cold plate 400 furthest from the coolant inflow 402, such as battery cell 405C, for example, and coolest on the cold plate 400 closest to the coolant inflow 402, such as battery cell 405B, for example. Battery cell 405B is the coolest battery cell 405A-Z in part due to receiving the least warmed coolant circulating from the rest of the cold plate 400: pressure of cool coolant entering from the coolant inflow 402 blocks warm coolant from recirculating up towards the corner that battery cell 405B resides in. Battery Cell 405D is warmer than battery cell 405B because coolant flowing across the cold plate 400 from the coolant inflow 402 is warmed upon passing the battery cells 405E-Z in the middle of the cold plate 400. Battery Cell 405A is also warmer than battery cell 405B, and might be expected to be the warmest battery cell 405A-Z on the cold plate 400 due to the proximity to the coolant outflow 404, which is the intended path of heat expression from the cold plate 400. However, because battery cell 405A is also so close to the coolant inflow 402, battery cell 405 is also cooled by the immediately entering coolant. In fact, the heat gradient diagram shows cold coolant flowing in the inflow 402, and immediately cooling the coolant at the coolant outflow 404—ultimately not cooling any of the battery cells 405A-Z at all, and limiting the value of the cold plate 400 to even function as a cold plate. A temperature difference of approximately ten degrees Celsius is depicted between battery cell 405B and battery cell 405C, which is substantially higher than the ideal maximum temperature differential of three degrees Celsius.

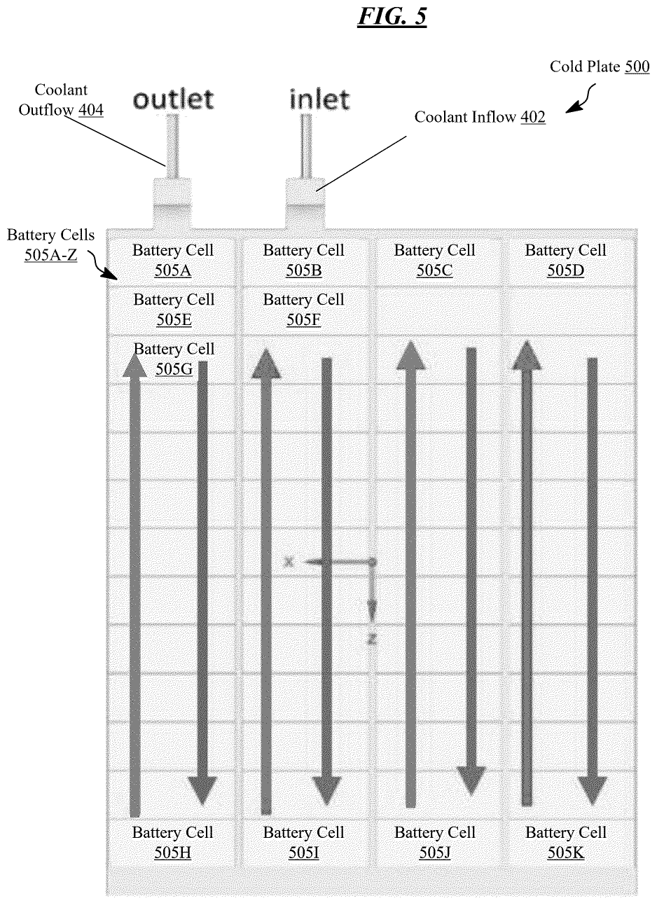

FIG. 5 is a top-down diagram of a preferred coolant flow across a cold plate 500 in order to reduce temperature variance among battery cells 505A-Z in a battery storage element 106A. The cold plate 500 is oriented and constructed similarly to the cold plate 400, except the cold plate 500 has means of flowing all of the cold coolant from the coolant inflow 402 down the battery cells 505A-Z proportionally, and then flowing the warmed coolant at the far end of the cold plate 500 back across the battery cells 505A-Z proportionally toward the coolant outflow 404.

A design implementing the principles of cold plate 500 would result in the first battery cells of each column (e.g., battery cells 505A-D) receiving the same amount of cooling as each of these battery cells experiences the coldest cold coolant, and the hottest hot coolant, which would average to average coolant at an optimized coolant flow rate. Similarly, the last battery cells of each column (e.g., battery cells 505H-K) receive the same amount of cooling as each other, as well as the same amount of cooling as battery cells 505A-D: battery cells 505H-K experience the hottest cold coolant, and the coldest hot coolant, which would average to average coolant at the optimized coolant flow rate. Therefore, as the first row of battery cells 505A-D and the last row of battery cells 505H-K all experience the same average temperature coolant, by mathematical induction all of the intermediate battery cells (e.g., battery cells 505E-G) also experience average temperature coolant.

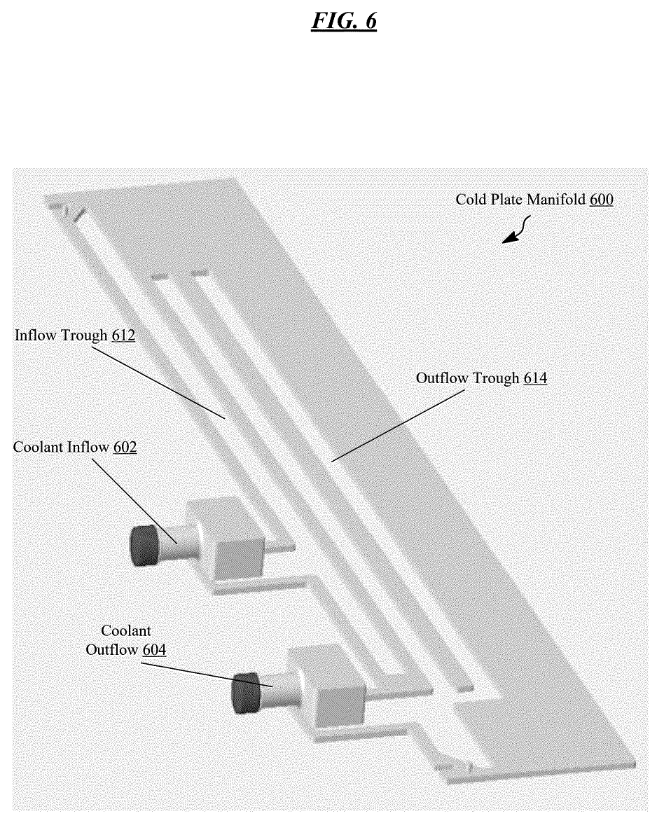

FIG. 6 is an isometric view of a cold plate manifold 600 configured to improve temperature variance among battery cells in a battery storage element 106A. In order to accomplish the even temperature distribution depicted in FIG. 5, the coolant flow distribution needs to be broken up into a two-pass system running in the Y direction of the cold plate. However, a two-pass system cannot be accomplished effectively without having a design that allows coolant to return to the front of the cold plate. Therefore, coolant manifold 600 splits coolant flow in a bi-directional (over/under) type configuration at the front and interior of the cold plate.

Cold coolant enters the coolant manifold 600 at the coolant inflow 602, and travels along an inflow trough 612, where it will enter the channels of the cold plate. As the warmed coolant is cycled through the cold plate, it is returned to an outflow trough 614, where the warmed coolant flows towards the coolant outflow 604. The inflow trough 612 is arranged to be higher than the outflow trough 614, thereby allowing coolant to flow from the inflow trough 612, over the cold plate, and to the outflow trough 614.

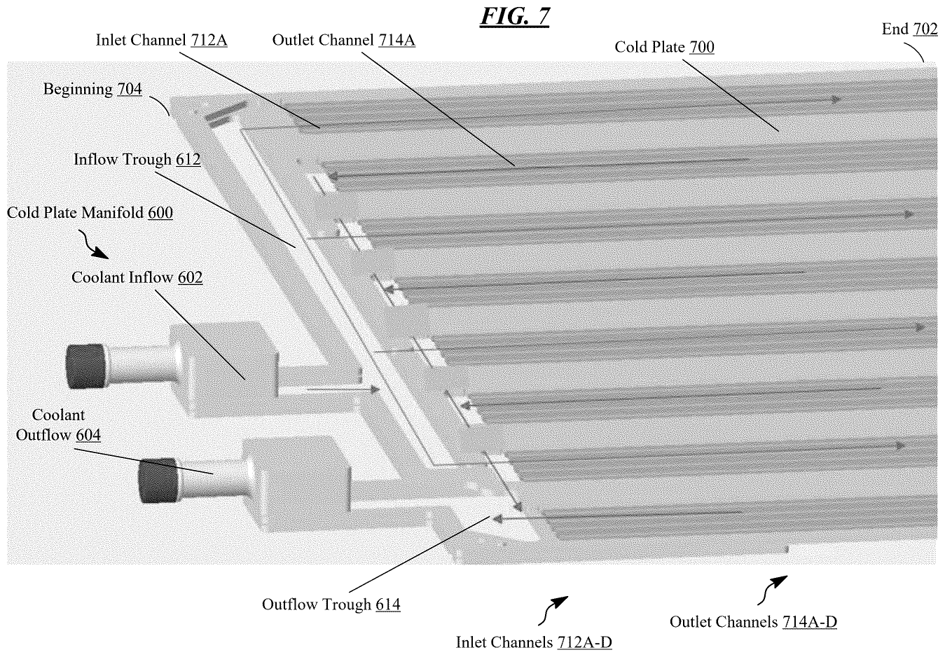

FIG. 7 is an isometric view of the cold plate manifold 600 of FIG. 6 coupled to a cold plate 700, with arrows indicating the flow of coolant across the cold plate 700. For example, the cold plate manifold 600 can be brazed or welded to the cold plate 700, e.g., by soldering or melting a filler metal or an alloy of copper and zinc at a high temperature.

The cold plate 700 includes a plurality of inlet channels 712A-D and a plurality of outlet channels 714A-D. In the embodiment depicted in FIG. 7, each of the plurality of inlet channels 712A-D and the plurality of outlet channels 714A-D includes at least four sets of inlet channels 712A-D and at least four sets of outlet channels 714A-D. However, embodiments are not limited to at least four sets of inlet channels 712A-D and outlet channels 714A-D, and any other number of sets of inlet channels 712A-D and outlet channels 714A-D may be utilized so long as there is at least one set of inlet channels 712A-D and at least one set of outlet channels 714A-D for each battery cell 505A-Z.

The inlet channels 712A-D are arranged at the same elevation level (e.g., same plane) as the outlet channels 714A-D.

The inlet channels 712A-D can be tunable. For example, the size and/or the design of the inlet channels 712A-D can be varied during the design of the cold plate 700.

The cold plate manifold 600 illustrated in FIG. 7 creates a flow path for the coolant entering from the coolant inflow 602 to travel through the inflow trough 612 and splits the coolant flow path to travel down each of the four sets of inlet channels 712A-D. Coolant entering from the coolant inflow 602 travels through the inflow trough 612 and splits its coolant flow path to travel down to each of the plurality of inlet channels 712A-D toward the end 702 (e.g. relative to the coolant inflow 602) of the cold plate 700. As the coolant reaches the end 702 of the cold plate 700, the coolant drops down and flows back towards the beginning 704 of the cold plate 700 along each of the four sets of outlet channels 714A-D. Then, the coolant drops again from the outlet channels 714A-D into the outflow trough 614, where the coolant flows to the coolant outflow 604 to be re-cooled and recycled through the system.

In the example depicted in FIG. 7, each set of inlet channels 712A-D is paired with the adjacent set of outlet channels 714A-D. A battery cell would reside over top both the set of inlet channels 712A and the set of outlet channels 714A-D. For example, a battery cell can be arranged above the same number of the at least four sets of inlet channels 712A-D and the at least four sets of outlet channels 714A-D. Therefore, the coolant flowing back via the outlet channels 714A-D is predominantly carrying the heat picked up while flowing through the inlet channels 712A-D provided by the battery cells arranged directly above the inlet channels 712A-D and the outlet channels 714A-D associated with the same battery cells.

It is contemplated that each of the inlet channels 712A-D could indiscriminately connect to at least one (e.g., adjacent) outlet channel of the outlet channels 714A-D, resulting in a mixed coolant flow back toward the outflow trough 614.

It is contemplated that a battery cell could span above more than one set of inlet channels 712A-D and above more than one set of outlet channels 714A-D, depending on the size of the battery cell, for example. It is preferred for a battery cell to span above the same number of sets of inlet channels 712A-D and sets of outlet channels 714A-D in order to balance heat dispersal.

A consideration that allows the heat dissipation system illustrated in FIG. 7 to be effective is that, within a battery storage element 106A, a battery cell is relatively easily capable of inducing heat transfer within itself, such that the average temperature is very close to a sampled temperature of a random location within the battery cell. However, battery cells within the battery storage element 106A are relatively incapable of inducing heat transfer between each other, such that the average temperature of all of the battery cells within the battery storage element 106A may not be particularly representative of a sampled temperature of a random battery cell within the battery storage element 106A. Therefore, to achieve temperature uniformity across battery cells, intra-heat transfer can be generally deprioritized, while inter-heat transfer can be focused on by coolant systems in battery modules of battery energy storage systems.

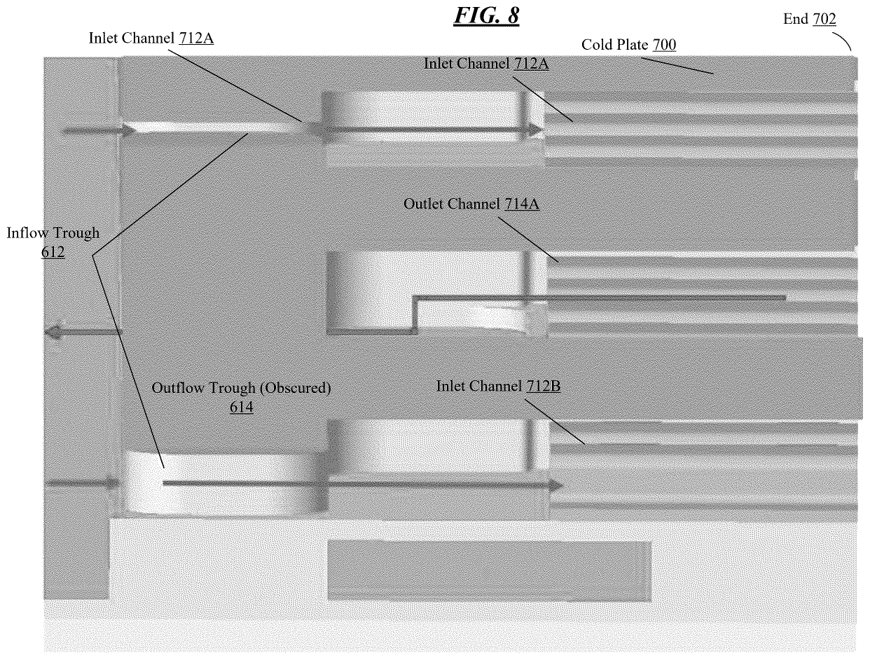

FIG. 8 a top-down view of the cold plate 700 of FIG. 7, depicting the flow path of coolant at the junction between the cold plate 700 and the cold plate manifold 600. The coolant can be seen entering and flowing through the inflow trough 612. A drop down is depicted by the shadows in the view, showing an elevation drop to the inlet channels 712A-B. The coolant flows over the drop down, and into the inlet channels 712A-B, following the elevation drop. The coolant then flows down the inlet channels 712A-B, reaches the end 702, and flows back down the outlet channel 714A. Another drop down is depicted by the shadows in the view of FIG. 8, showing another elevation drop from the outlet channel 714A to the obscured outflow trough 614. Thus, the coolant drops at least twice: from the inflow trough 612 to the inlet channels 712A-B, and from the outlet channel 714A to the outflow trough 614. There may be an additional drop between the inlet channel 712A and the outlet channel 714A to prevent backflow of the coolant. Alternatively, the pressure of the coolant may be sufficient and sustained enough that a drop down between the inlet channels 712A and the outlet channels 714A may not be necessary.

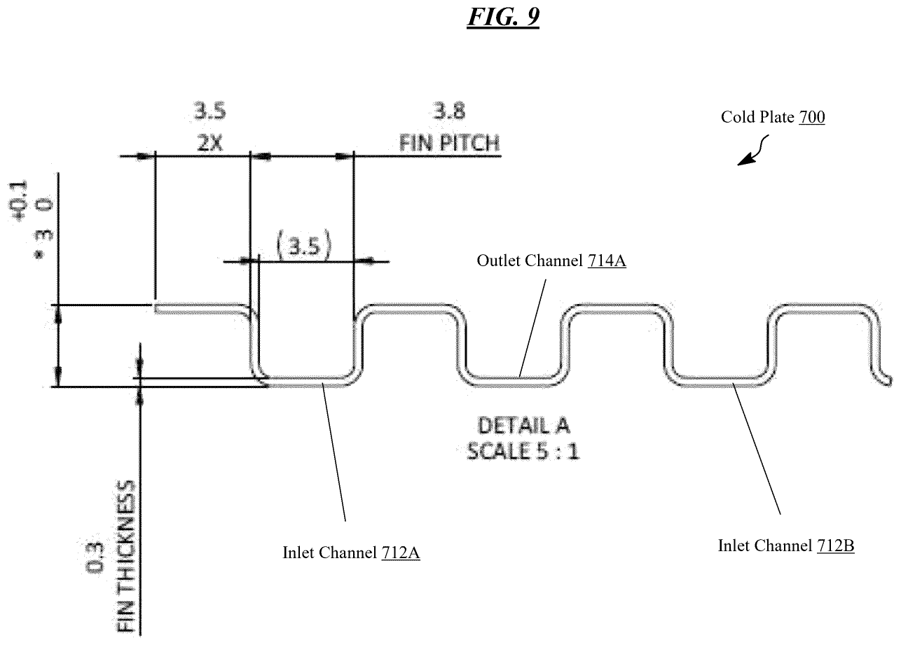

FIG. 9 is a longitudinal view of the cold plate 700 of FIG. 7, depicting inlet channels 712A-B and an outlet channel 714A for the coolant. As illustrated in FIG. 9 and as described with reference to FIG. 7, the inlet channels 712A-B are arranged at the same elevation level (e.g., same plane) as the outlet channel 714A.

However, embodiments are not limited to this configuration. For example, in an alternative design, the outlet channel 714A may be arranged at a lower elevation than the inlet channels 712A-B, to reduce coolant backflow, while maintaining the velocity of the coolant flow.

In certain embodiments, multiple (e.g., more than one) cold plates 500, 700 can be coupled to the battery storage elements 106A-N of the energy storage nodes 105A-N. For example, a separate cold plate 500, 700 can be coupled to each battery storage element 106A-N of the energy storage nodes 105A-N.

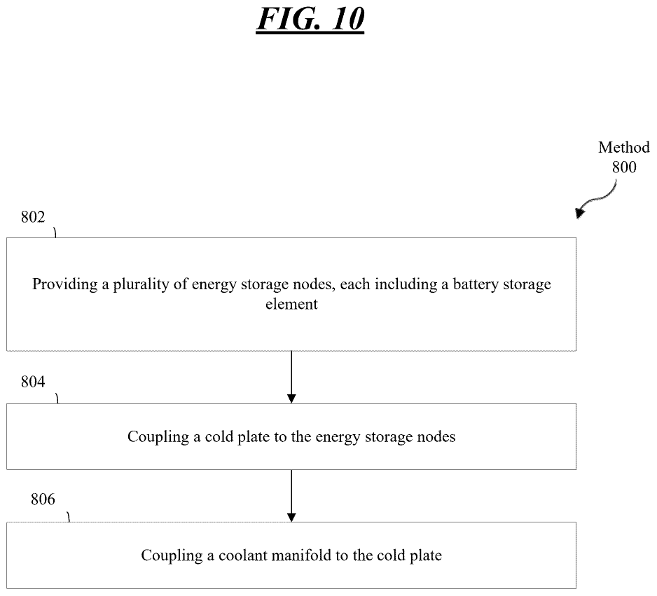

FIG. 10 is a flowchart of a method 800 for assembling an energy storage system 101.

Beginning in step 802, the method 800 includes providing a plurality of energy storage nodes 105A-N, each of which includes a battery storage element 106A-N (FIG. 2). The energy storage nodes 105A-N can include a battery storage element 106, a power conversion subsystem 107, and a control subsystem 110 to receive the battery data 111A-N from the battery storage element 106, the power conversion subsystem 107, or a combination thereof.

Continuing to step 804, the method 800 further includes coupling at least one cold plate 500, 700 to each of the plurality of energy storage nodes 105A-N.

Continuing to step 806, the method 800 further includes coupling a coolant manifold 600 to the at least one cold plate 500, 700. The coolant manifold 600 is configured to split coolant flow in a bi-directional type configuration at a front and in an interior of the cold plate 500, 700.

Although not shown in FIG. 8, before step 804, the method 800 can further include a step of arranging a plurality of inlet channels 712A-D and a plurality of outlet channels 714A-D on the at least one cold plate 500, 700. The plurality of inlet channels 712A-D and the plurality of outlet channels 714A-D can be arranged at the same elevation level.

Although not shown in FIG. 8, before step 804, the method 800 can further include a step of arranging at least one battery cell 505A-Z of the energy storage element 106A-N above both at least one of the plurality of inlet channels 712A-D and at least one of the plurality of outlet channels 714A-D of the at least one cold plate 500, 700. The at least one battery cell 505A-Z is arranged above the same number of the plurality of inlet channels 712A-D and the plurality of outlet channels 714A-D of the at least one cold plate 500, 700.

The thermal regulation technologies disclosed herein allow for flowing coolant as evenly as possible across a cold plate with a surface area greater than 700 mm×500 mm, e.g., of approximately 1000 millimeters by 700 millimeters, cooling approximately fifty battery cells. The cold plate described herein can have dimensions of approximately 700 millimeters to 1000 millimeters by 500 millimeters to 700 millimeters. For example, the cold plate can have dimensions of 963 mm×698 mm, accommodating attachment to 52 battery cells, and allowing flow of coolant to cool as evenly as possible throughout the entirety of the cold plate.

Further, the battery cells cooled by the thermal regulation technologies disclosed herein can be cooled within a range of no greater than ±three degrees Celsius distribution.

The thermal regulation design disclosed herein allows for a narrow inlet and outlet space to increase energy density, as well as optimize coolant flow.

The thermal regulation design disclosed herein allows for space savings by separating the inlet and return of the cooling system by utilization of a collection area above and below the separating manifold.

The thermal regulation technologies disclosed herein can achieve better heat transfer from battery cells to the cooling media, thereby improving improve the lifespan and the overall power flow of a battery energy storage system to provision power flow for an electrical application. The improved lifespan and improved power flow can lower operating costs and improve operational safety.

It will be understood that the terms and expressions used herein have the ordinary meaning as is accorded to such terms and expressions with respect to their corresponding respective areas of inquiry and study except where specific meanings have otherwise been set forth herein. Relational terms such as first and second, or evident and alternative, and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as +5% or as much as +10% from the stated amount. The terms “approximately” and “substantially” mean that the parameter value or the like varies up to +10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

What is claimed is:

1. An energy storage system, comprising:
a plurality of energy storage nodes, wherein each of the plurality of energy storage nodes includes an energy storage element;
at least one cold plate; and
a coolant manifold coupled to the at least one cold plate,
wherein the coolant manifold is configured to split coolant flow in a bi-directional type configuration at a front and in an interior of the cold plate.

2. The energy storage system of claim 1, wherein the at least one cold plate comprises a plurality of inlet channels and a plurality of outlet channels.

3. The energy storage system of claim 2, wherein the plurality of inlet channels are arranged at the same elevation level as the plurality of outlet channels.

4. The energy storage system of claim 2, wherein the plurality of inlet channels are tunable.

5. The energy storage system of claim 2, wherein the energy storage element comprises at least one battery cell arranged above both at least one of the plurality of inlet channels and at least one of the plurality of outlet channels.

6. The energy storage system of claim 2, wherein the plurality of inlet channels comprises at least one set of inlet channels and the plurality of outlet channels comprises at least one set of outlet channels.

7. The energy storage system of claim 6, wherein the at least one battery cell is arranged above the same number of the at least one set of inlet channels and the at least one set of outlet channels.

8. The energy storage system of claim 2, wherein the coolant manifold comprises a coolant inflow and an inflow trough, and wherein coolant entering from the coolant inflow travels through the inflow trough and splits coolant flow path to travel down to each of the plurality of inlet channels toward an end of the cold plate.

9. The energy storage system of claim 8, wherein the coolant manifold comprises a coolant outflow and an outflow trough, and wherein after the coolant reaches the end of the cold plate, the coolant flow path drops down and flows back towards a beginning of the cold plate along each of the plurality of outlet channels.

10. The energy storage system of claim 9, wherein each of the plurality of inlet channels is coupled to at least one of the plurality of outlet channels, and wherein mixed coolant flows back toward the outflow trough.

11. The energy storage system of claim 10, wherein the plurality of outlet channels comprise an elevation drop to the outflow trough, and wherein coolant follows the elevation drop from each of the plurality of outlet channels to the outflow trough.

12. The energy storage system of claim 1, wherein in the bi-directional type configuration, the coolant flows toward an end of the cold plate and back from the end of the cold plate in the same plane.

13. The energy storage system of claim 1, wherein in the bi-directional type configuration, the coolant manifold separates the coolant flow in both a vertical direction and a horizontal direction.

14. The energy storage system of claim 13, wherein the coolant manifold separates the coolant flow in both the vertical direction and the horizontal direction, while maintaining a velocity of the coolant flow by using sets of inlet channels and sets of outlet channels, and collection areas above and below the cold plate.

15. The energy storage system of claim 1, wherein the coolant manifold is brazed to the at least one cold plate.

16. A method for assembling an energy storage system, the method comprising:
providing a plurality of energy storage nodes, wherein each of the plurality of energy storage nodes includes a battery storage element;
coupling at least one cold plate to each of the plurality of energy storage nodes; and
coupling a coolant manifold to the at least one cold plate,
wherein the coolant manifold is configured to split coolant flow in a bi-directional type configuration at a front and in an interior of the cold plate.

17. The method of claim 16, wherein the at least one cold plate comprises a plurality of inlet channels and a plurality of outlet channels.

18. The method of claim 17, further comprising arranging the plurality of inlet channels and the plurality of outlet channels at the same elevation level.

19. The method of claim 17, further comprising arranging at least one battery cell of the energy storage element above both at least one of the plurality of inlet channels and at least one of the plurality of outlet channels.

20. The method of claim 19, wherein the at least one battery cell is arranged above the same number of the plurality of inlet channels and the plurality of outlet channels.
